(19) United States
(12) Patent Application Publication
(10) Pub. No.: US 2006/0216685 A1
(43) Pub. Date: Sep. 28, 2006

(54) Interactive speech enabled flash card method and system

(75) Inventors: John Brodie, Davie, FL (US); Pedro McGregor, Sunrise, FL (US)

Correspondence Address: SACCO & ASSOCIATES, PA, P.O. BOX 30999, PALM BEACH GARDENS, FL, 33420-0999, US

(73) Assignee: INTERACTIVE SPEECH SOLUTIONS, LLC, Plantation, FL (US)

(21) Appl. No.: 11/387,432

(22) Filed: Mar. 23, 2006

Related U.S. Application Data
(60) Provisional application No. 60/665,288, filed on Mar. 25, 2005.

(51) Int. Cl. G09B 7/00

(52) U.S. Cl. 434/323

(57) ABSTRACT

A method for learning that combines physical, verbal and visual interaction between a computer processing device (102) and a user. The method includes building an assessment matrix and generating an interactivity model for the user. The method also includes outputting one or more questions and associated answer choices to the user. The questions and answers can be outputted to a display device (202) of the computer processing device and/or to a speaker (202) of the computer processing device. The method further includes receiving an answer input from the user. Data associated with the answer input is processed by the computer processing device for building a user performance table. A response can be generated based on the answer input and in accordance with a verbal response mode (450). The response is then outputted to the display device and/or the speaker. Subsequently, the assessment matrix is modified to accommodate a level of expertise demonstrated by the user. A computer program product for learning that combines physical, verbal and visual interaction to assess and help raise the skill levels of various users is also provided.

### CROSS REFERENCE TO RELATED APPLICATIONS

This application claims benefit of U.S. provisional patent application Ser. No. 60/665,288, filed on Mar. 25, 2005, which is herein incorporated by reference.

### BACKGROUND OF THE INVENTION

1. Statement of the Technical Field

The present invention relates to educational computer software and, more particularly, to speech-enabled, interactive educational software.

2. Description of the Related Art

There are various techniques known in the art for teaching. Some techniques are implemented in the hardware and the software of a computer processing device. Such techniques often rely on pre-recorded voice files for communicating verbal responses to a user.

Despite such known techniques for teaching, there is a need for an enhanced learning system that manipulates and uses verbal speech. A system is also needed that does not rely on pre-recorded voice files but will utilize a text-to-speech engine to convert text to speech. The program also needs to have the ability to simultaneously control two or more speech engines to allow a user to hear questions and support information in multiple languages. In this way, the system will be able to assist various users who have not yet mastered the primary language or are working to learn a secondary language. The method also needs to provide users with the ability to edit and add spoken content through an easy to use interface. Such an application will allow a user to create and/or edit a database and this includes data relating to verbal and textual instructional material. The system needs to be able to operate independent of the Internet or to have its operation integrated with on-line support. Finally, all application activity needs to be captured such that it can be viewed locally or sent to a central location.

A system is also needed that does not rely on pre-recorded audio files to add spoken words to the application. The application needs to have its own database development tool giving the user control over content. Beyond study/teaching/learning/testing content, a separate database needs to be provided that controls the computer's verbal interaction with the user, separate from the study/teaching/learning/testing content. This database of content can be used not only to support the teaching process with encouragement and advice but to give the computer “personality”. The application needs to be able to function almost completely through speech interaction. The basic program needs to provide a computer processing device with the ability to talk to a user through a two-way speech interaction between the user and the computer processing device. Furthermore, the system needs to provide to a user the ability to verbally enter new content while the computer processing device responds and prompts actions verbally.

A method is needed that utilizes existing speech engines to give the computer the ability to interact verbally with the user through existing or user created content databases in one or more languages simultaneously. Such a system can enhance the learning process by combining the three primary learning styles of visual, auditory and kinesthetic. Moreover, such a system can convert a computer processing device into a talking “virtual teacher” or tutor that can convey personality and a unique combination of interactive elements to maximize its effectiveness as a teaching tool.

### SUMMARY OF THE INVENTION

A method for learning that combines physical, verbal and visual interaction between a computer processing device and a user. The method includes building an assessment matrix and generating an interactivity model for the user. The method also includes outputting one or more questions and associated answer choices to the user. The questions and answers can be outputted to a display device (in a text format) and/or to one or more speakers (in a in a speech format). The method further includes receiving answer inputs from the user utilizing an input device such as a keyboard or a microphone. Data associated with the answer inputs is processed by the computer processing device for building a user performance table. A response can be generated based on the answer inputs. The response is then outputted to a display device (in a text format) and/or to one or more speakers (in a in a speech format). The assessment matrix is also modified to accommodate a level of expertise demonstrated by the user. Also, a report can be generated and stored in a database. The report can be outputted to a display device or to an external device, such as a printer.

In accordance with an aspect of the invention, the ‘building an assessment matrix’ step includes receiving speed level and difficulty level inputs from a user. The speed level and difficulty level inputs are stored in a database. The ‘outputting at least one question step’ includes outputting the questions and answer choices to a display device (in a text format) and/or to one or more speakers (in a in a speech format). The ‘generating a response step’ includes generating the response in accordance with a verbal response mode. The verbal response mode can be selected by a user. For example, a graphical user interface can include a ‘verbal response mode’ drop down menu. The ‘verbal response mode’ drop down menu can include a group consisting of a supportive mode, an encouraging mode, a sarcastic mode, a humorous mode, and/or a stern mode. Each mode can include a set of predefined computer speech outputs associated with specific user actions. For example, the supportive mode can provide a system for a speech output of “good job” in response to an input of a correct answer to a presented question. The response can be outputted to a display device (in a text format) and/or to one or more speakers (in a speech format).

In accordance with another aspect of the invention, the method further includes outputting one or more clues to assist the user in correctly answering a presented question. The clues can be outputted in response to a user action. For example, a graphical user interface includes a ‘show clues’ button. The user action consists of clicking the ‘show clues’ button. The clues can be outputted to a display device (in a text format and/or a graphic format) and/or to one or more speakers (in a speech format).

In accordance with another aspect of the invention, the method further includes placing a test mode, a study mode, or a quiz mode in an active state. This step can require a user action including clicking a ‘go to test mode’ button or ‘go to study mode’ button provided by a graphical user interface. The method can also include timing a test, a quiz or a study session. This step can be can be performed in response to a user action, such as selecting a time from a ‘set quiz/test time’ drop down menu provided by a graphical user interface.

In accordance with another aspect of the invention, the method can include providing a configurable interactive learning system to a user. For example, a question and associated answer choices can be added by a user, deleted by a user, or edited by a user. The new or edited questions and answer choices are stored in a memory device, such as a database. A category can be added, by a user or deleted by a user. Similarly, a subcategory can be added by user or deleted by a user. A new category and subcategory can be stored in a memory device, such as a database.

A computer program product for learning that combines physical, verbal and visual interaction to assess and help raise the skill levels of a user is also provided. The computer program product includes a computer readable storage medium having computer readable code embodied in the medium. The computer readable program code includes computer readable program code configured to build an assessment matrix and to generate an interactivity model for the user. The computer readable program code is also configured to output one or more questions and associated answer choices to a display device or to one or more speakers. The computer readable program code is further configured to receive an answer input for the questions from the user. The user can input answer using an input device such as a keyboard or a microphone. The computer readable program code is configured to process the answer input to build a user performance table. A response is generated based on the answer input. Subsequently, the response is outputted to a display device and/or one or more speakers. The computer readable program code is also configured to modify the assessment matrix to accommodate a level of expertise demonstrated by the user. A report can also be generated and stored in a database. The report can be outputted to a display device and/or an external device, such as a printer.

In accordance with an aspect of the invention, computer readable program code configured to receive speed level and difficulty level inputs from a user is also provided. The speed level and difficulty level inputs are stored in a database. In accordance with another aspect of the invention, computer readable program code is also configured to generate a response in accordance with a verbal response mode. The verbal response mode can be selected by a user. For example, a graphical user interface can include a ‘verbal response mode’ drop down menu. The ‘verbal response mode’ drop down menu can include a group consisting of a supportive mode, an encouraging mode, a sarcastic mode, a humorous mode, and/or a stern mode. Each mode can include a set of predefined computer speech outputs associated with specific user actions. The response can be outputted to a display device (in a text format) and/or to one or more speakers (in a speech format).

In accordance with another aspect of the invention, computer readable program code is also configured to output one or more clues to assist a user in correctly answering a presented question. The clues can be outputted to a display device (in a text format and/or a graphic format) and/or to one or more speakers (in a speech format). The computer readable program code is also configured to place a test mode, a study mode, or a quiz mode in an active state. This configuration can require a user action. For example, a graphical user interface can include a ‘go to test mode’ button or ‘go to study mode’ button. The computer readable program code can also be configured to time a test, a quiz, or a study session. The computer readable program code can further be configured to set a speed level and a difficulty level for questions to be presented to a user.

In accordance with another aspect of the invention, computer readable program code is configured to provide a configurable interactive learning system to a user. In this regard, computer readable program code configured to allow a user to edit, delete, and/or add a question and associated answer choices. Similarly, computer readable program code configured to allow a user to edit, delete, and/or add a category or subcategory.

### BRIEF DESCRIPTION OF THE DRAWINGS

Embodiments will be described with reference to the following drawing figures, in which like numerals represent like items throughout the figures, and in which:

FIG. 1 is a block diagram of an interactive learning system architecture that is useful for understanding the invention.

FIG. 2 is a block diagram of a user computer processing device illustrated in FIG. 1.

FIG. 3 is a block diagram of a site computer processing device illustrated in FIG. 1.

FIG. 4 is a schematic illustration of a main graphical user interface that is useful for understanding the invention.

FIG. 5 is a schematic illustration of a graphical user interface that is useful for understanding the invention.

FIG. 6 is a schematic illustration of a graphical user interface that is useful for understanding the invention.

FIG. 7 is a schematic illustration of a graphical user interface that is useful for understanding the invention.

FIG. 8 is a schematic illustration of a graphical user interface that is useful for understanding the invention.

FIG. 9 is a schematic illustration of a graphical user interface that is useful for understanding the invention.

FIG. 10 is a schematic illustration of a graphical user interface that is useful for understanding the invention.

FIG. 11 is a schematic illustration of a graphical user interface that is useful for understanding the invention.

FIG. 12 is a schematic illustration of a graphical user interface that is useful for understanding the invention.

FIG. 13 is a schematic illustration of a graphical user interface that is useful for understanding the invention.

FIG. 14 is a flow diagram of a user process that is useful for understanding the invention.

FIG. 15 is a flow diagram of an interactive learning software routine that is useful for understanding the invention.

FIG. 16A though FIG. 16D collectively represents a flow diagram of a priority messaging engine software routine that is useful for understanding the invention.

### DETAILED DESCRIPTION OF THE PREFERRED EMBODIMENTS

The invention will now be described more fully hereinafter with reference to accompanying drawings, in which illustrative embodiments of the invention are shown. This invention, may however, be embodied in many different forms and should not be construed as limited to the embodiments set forth herein. For example, the present invention can be embodied as a method, a data processing system, or a computer program product. Accordingly, the present invention can take the form as an entirely hardware embodiment, an entirely software embodiment, or a hardware/software embodiment.

The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention can take the form of a computer program product on a computer-usable storage medium having computer-usable program code embodied in the medium (for example, a hard disk or a CD-ROM). The term computer program product, as used herein, refers to a device comprised of all the features enabling the implementation of the methods described herein, and which, when loaded in a computer system, is able to carry out these methods. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

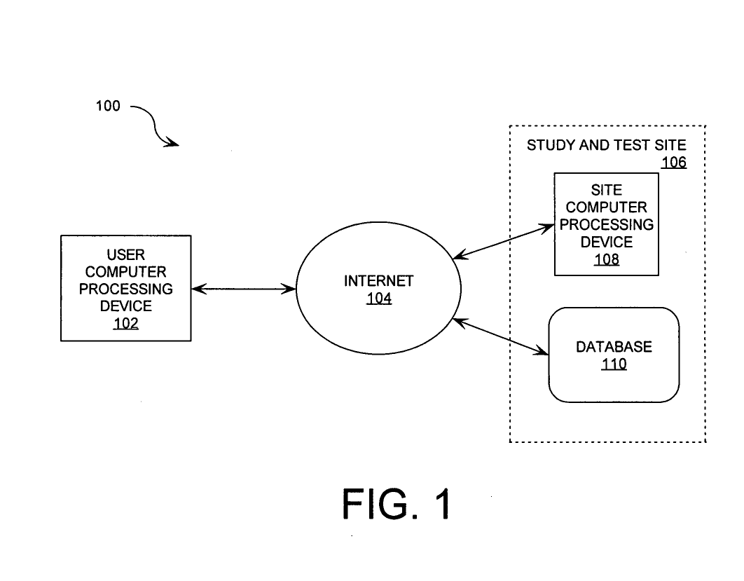

Embodiment of the present invention will now be described with respect to FIG. 1 through FIG. 14. Some embodiments of the present invention provide methods, systems, and apparatus relating to educational functions including the assessment of a user's educational skill level, the assistance in learning information, and the analysis of a user's ability to retain information. In accordance with the inventive arrangements disclosed herein, users can define a set of criteria, topics, and material for such educational functions. In one embodiment, the invention can be implemented in computer software to provide interactive flash cards that are speech-enabled. Such an embodiment provides two-way visual and auditory communication between a computer processing device and a user. In accordance with this embodiment, the flash cards are presented to a user for studying purposes and/or testing purposes.

Interactive Learning System Architecture

Referring now to FIG. 1, there is provided a block diagram of an interactive learning system architecture 100 that is useful for understanding the invention. The system architecture 100 is comprised of a user computer processing device 102, an Internet 104, and a study and test (S/T) site 106. The S/T site 106 is comprised of a site computer system 108 and a database 110. Although a single database is shown in FIG. 1, it should be understood that S/T site 106 can be comprised of any number of databases in accordance with a particular S/T site 106 application.

Database 110 is the S/T site's 106 storage medium comprising test data (e.g., test flash card data including test category data, test subcategory data, test question data, test answer data, and test question clue data) and/or study data (e.g., study flash card data including study category data, study subcategory data, study question data, study answer data, and study question clue data). A person skilled in the art will appreciate that the test data and the study data can be stored in database 110 according to any suitable population scheme, such as a table format. Database 110 can also include score data which can be stored in any suitable manner provided that the score data is associated with an associated user. Database 110 can include assessment data. The assessment data can be stored in database 110 in a matrix format. The assessment data can include speed level data and degree of difficulty data. According to an embodiment of the invention, an assessment matrix can represent an interactive model for a given user. For example, the degree of difficulty data can include a level of forty-seven (47) on a scale of one-to-one hundred (1-100) for a user having a fifth (5^{th}) grade education. A set of suitable fifth (5^{th}) grade study questions can be stored in database 110 in a manner such that each question is associated with level forty-seven (47).

User can access database 110 by accessing and entering the S/T site 106. In accordance with an embodiment of the invention, the user computer processing device 102 accesses S/T site 106 through the Internet using an Internet Service Provider. However, it should be understood that the user computer processing device 102 can alternatively be connected to the site computer system 108 through a local area network (LAN) or a wide area network (WAN).

Site computer system 108 can communicate with the user computer processing device 102 through the Internet using an Internet Service Provider. Site computer system 108 can access database 110 through the Internet using an Internet Service Provider. It should be understood that the site computer system 108 can alternatively be connected to database 110 through a local area network (LAN) or a wide area network (WAN). Alternatively, site computer system 108 can have a direct connection to database 110.

A person skilled in the art will appreciate that the system architecture 100 is one embodiment of a system architecture in which the methods described below can be implemented. The invention is not limited in this regard and any system architecture can be used without limitation.

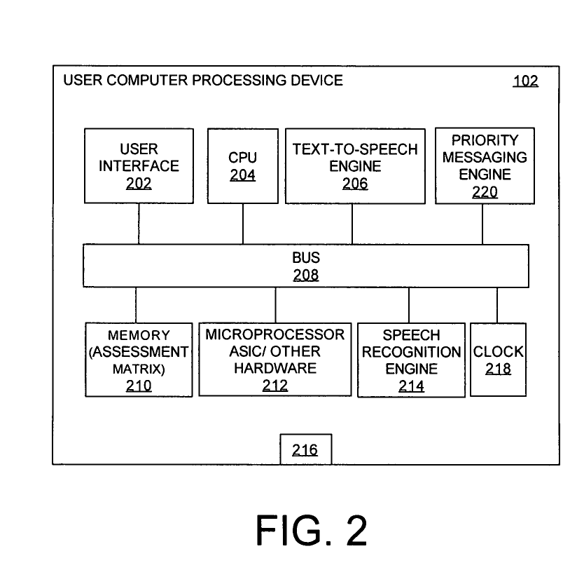

Referring now to FIG. 2, there is provided a detailed block diagram of the user computer processing device 102 shown in FIG. 1. It should be understood that user computer processing device 102 can be selected as a desktop personal computer system, a laptop personal computer system, a personal digital assistant (PDA), or any other general purpose computer processing device.

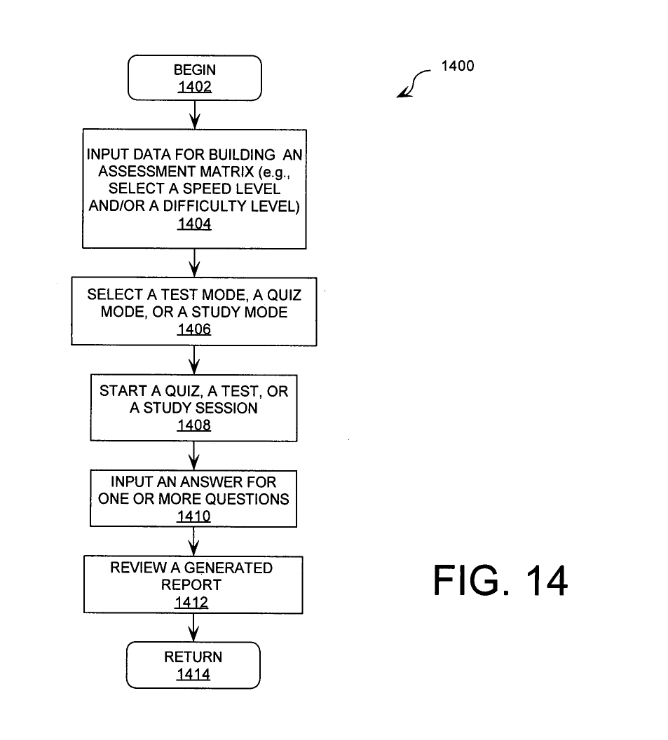

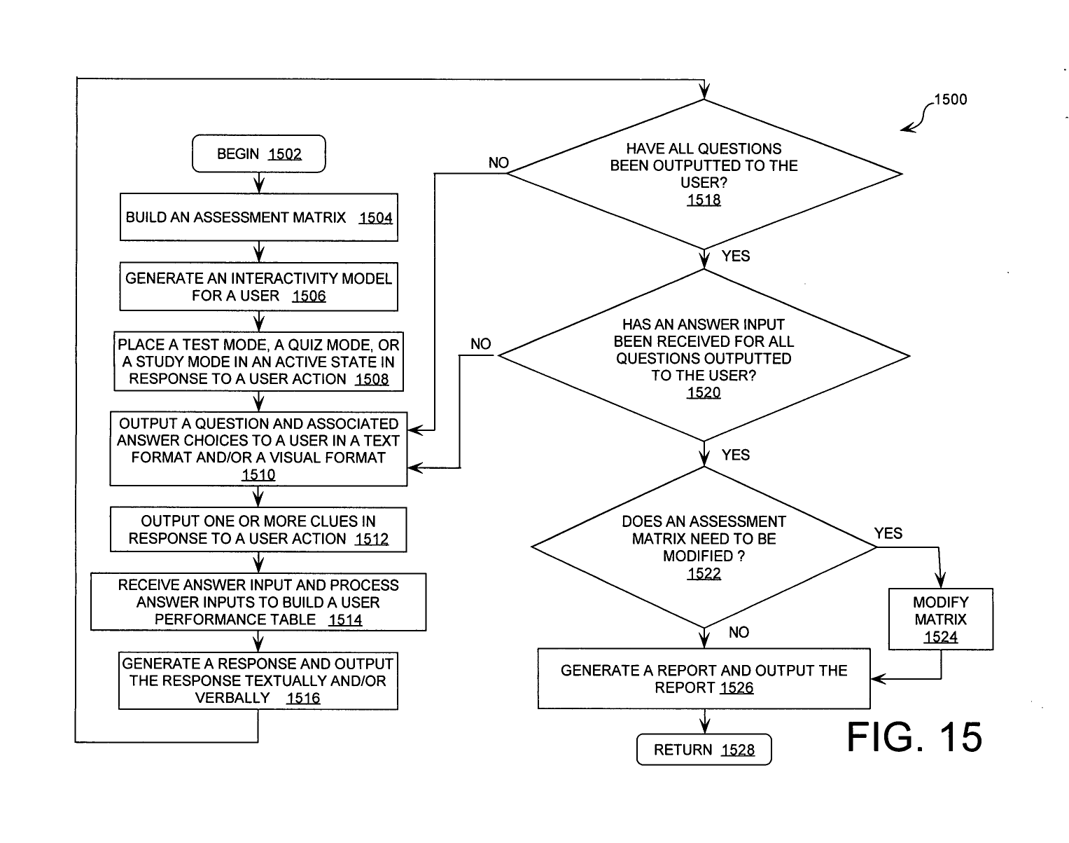

User computer processing device 102 is comprised of a system interface 216, a user interface 202, a central processing unit 204, a text-to-speech engine 206, a speech recognition engine 214, a clock 218, a priority messaging engine 220, a system bus 208, a memory 210 connected to and accessible by other portions of the user computer processing device 102 through system bus 208, and hardware entities 212 connected to system bus 208. At least some of the hardware entities 212 perform actions involving access to and use of memory 210, which may be a RAM, a disk driver, and/or a CD-ROM. Hardware entities 212 may include microprocessors, ASICs, and other hardware. Hardware entities 212 may include a microprocessor programmed for connecting with S/T site 106, accessing database 110, transmitting data to database 110, and retrieving data from database 110. Hardware entities 212 may further include a microprocessor programmed for accessing and launching an interactive learning software routine. The interactive learning software routine will be described in detail below (in relation to FIG. 14 through FIG. 15). Hardware entities 212 can also include a microprocessor programmed with a broadcast application. The broadcast application can provide a system for entering text messages which can be sent to a location of choice on the Internet. Broadcast applications are well know to persons skilled in the art. Thus, broadcast applications will not be described in great detail herein.

User interface 202 facilitates a user action to query database 110, transmit data to database 110, and retrieve data from database 110. User interface 202 also facilitates a user action to create a request for launching an interactive software application for assessing a user's educational skill level, assisting a user in learning information, and testing a user on a defined set of materials. User interface 202 further facilitates a user action to determine test criteria, define test criteria, define the content of test materials, define the content of study materials, generate reports, store a generated report, email a generated report to a third party, or print a generated report. User interface 202 facilitates a user action to assign an identification number to a particular set of test materials. User interface 202 can be comprised of a display screen, speakers, and an input means, such as a keypad, directional pad, a directional knob, stylus, and/or a microphone.

System interface 216 allows the user computer processing device 102 to communicate with the S/T site 108 through the internet, LAN, or WAN. System interface 216 also allows the user computer processing device 102 to communicate with one or more external computer systems 108 and one or more databases 110 over the internet, LAN, WAN.

Processing performed by the user computer processing device 102 is performed in software using hardware entities 212. The user computer processing device 102 can support any software architecture commonly implemented on a computer processing device. Such software architectures typically include an operating system, for example, Windows 98, Windows 2000, Windows NT, and Windows XP.

Text-to-speech engine 206 is a speech synthesizer that converts text into speech. Text-to-speech engine 206 can be comprised of hardware and a text-to-speech software application. Text-to-speech engine 206 in conjunction with user interface 202 (i.e., speakers) can output data to one or more speakers in a speech format. Text-to-speech engine 206 can be selected to include multi-language capabilities. Text-to-speech engines are well known to persons skilled in the art. Thus, text-to-speech engines will not be described in great detail herein.

Speech recognition engine 214 interprets human speech for transcription. Speech recognition engine 214 can be selected to include multi-language capabilities. For example, speech recognition engine 214 can interpret various spoken language inputs, such as English, German, Spanish and any other universally recognized language. Speech recognition engines are well known to persons skilled in the art. Thus, speech recognition engines will not be described in great detail herein.

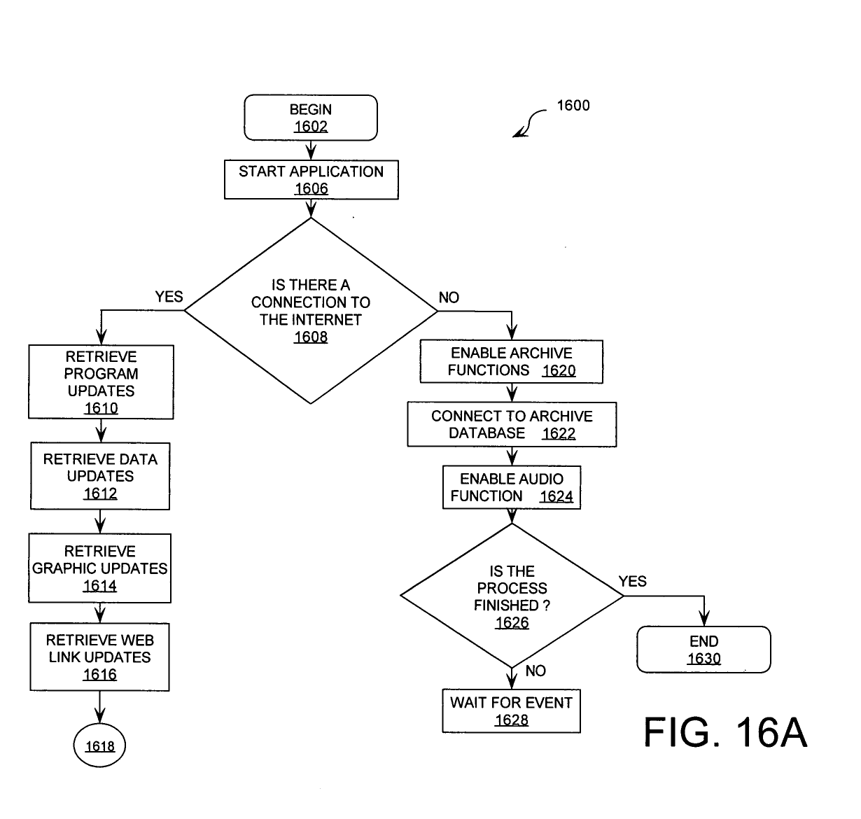

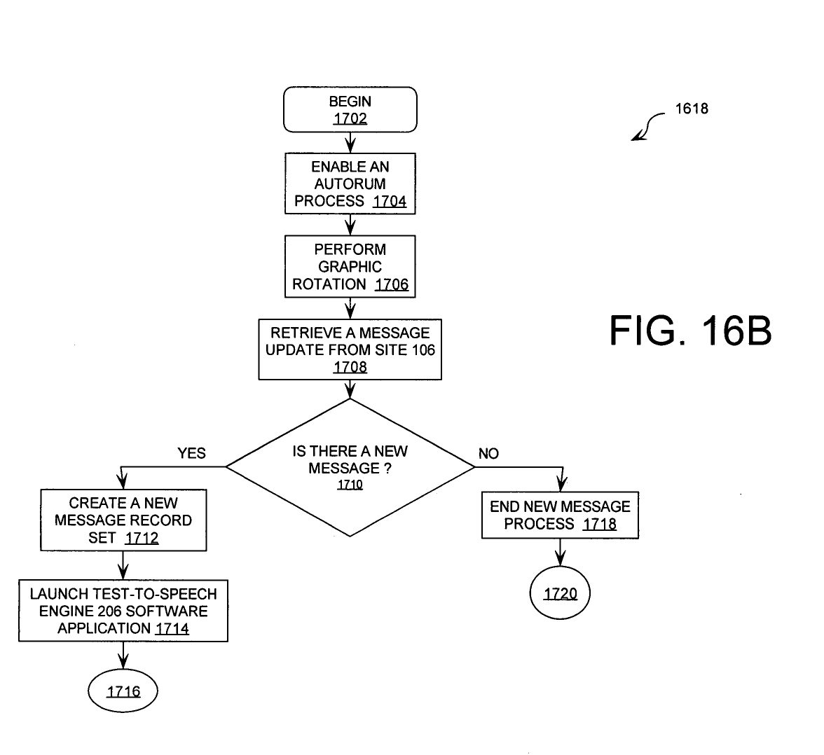

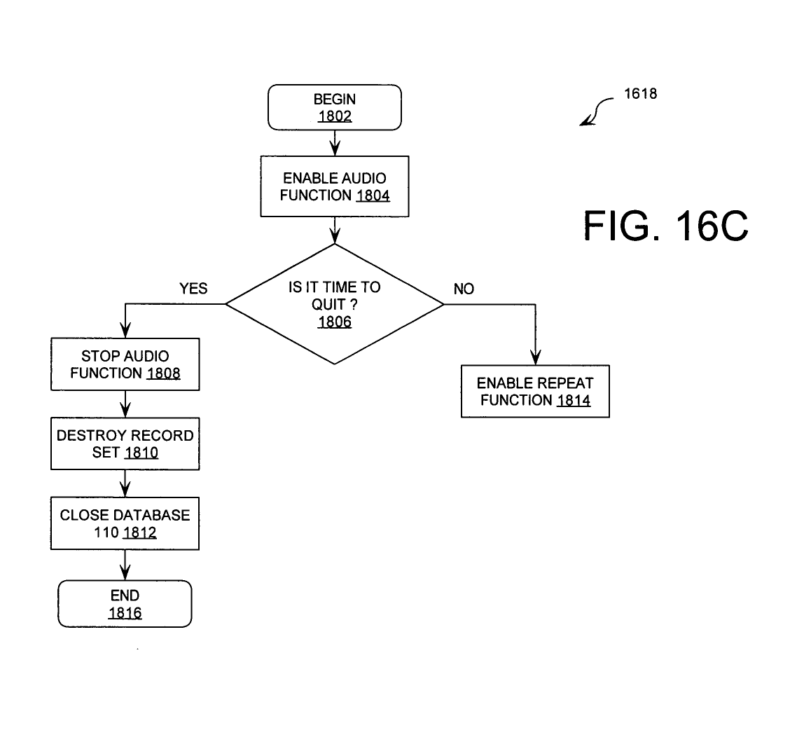

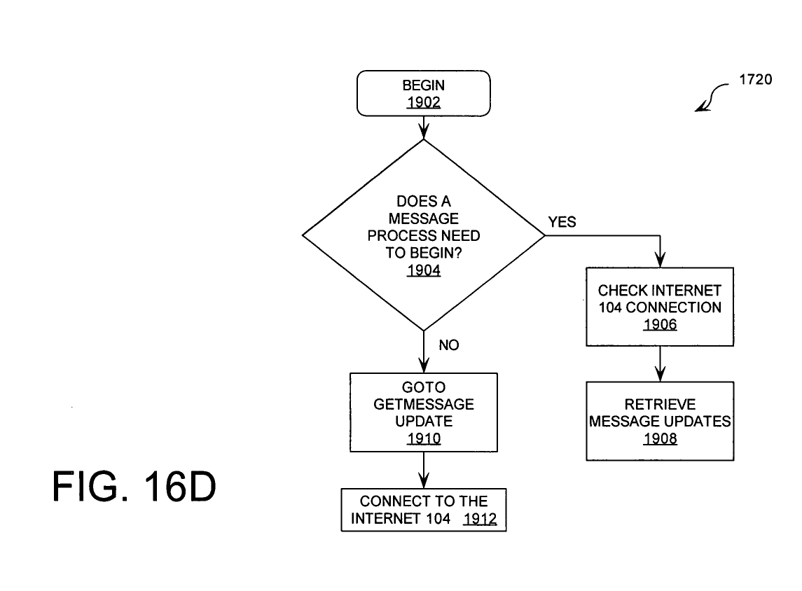

Priority messaging engine 220 is a web based message delivery system that provides text message retrieval and delivery as spoken words by a computer processing device. Priority messaging engine 220 can include hardware and software. A priority messaging engine 220 software routine will be described in great detail below (in relation to FIG. 16A through FIG. 16D).

Those skilled in the art will appreciate that the user computer processing device architecture illustrated in FIG. 2 is one possible example of a computer processing device in which the interactive learning software routine described below can be implemented. However, the invention is not limited in this regard and any other suitable computer processing device architecture can also be used without limitation.

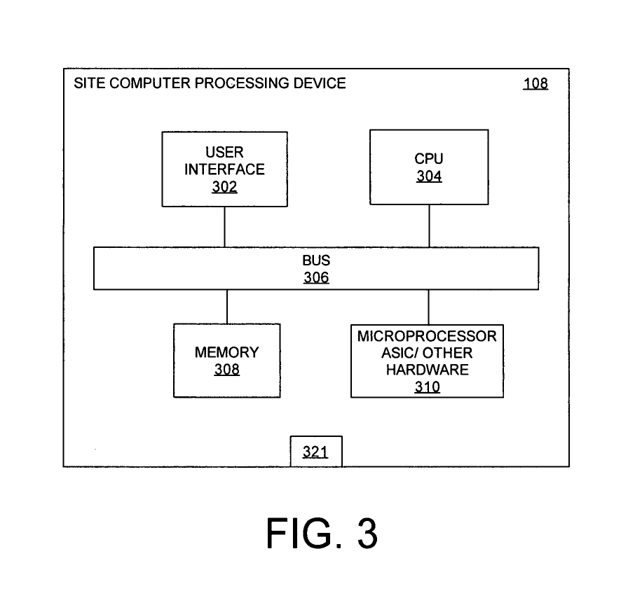

Referring now to FIG. 3, there is provided a detailed block diagram of the site computer processing device 108 shown in FIG. 1. Site computer processing device 108 is comprised of a system interface 321, a user interface 302, a central processing unit 304, a system bus 306, a memory 308 connected to and accessible by other portions of the site computer processing device 108 through system bus 306, and hardware entities 310 connected to system bus 306. At least some of the hardware entities 310 perform actions involving access to and use of memory 308, which may be a RAM, a disk driver, and/or a CD-ROM. Hardware entities 310 may include microprocessors, ASICs, and other hardware. Hardware entities 310 may include a microprocessor programmed for accessing database 110, transmitting data to database 110, and retrieving data from database 110. Hardware entities 310 may also include a microprocessor programmed with a broadcast application. The broadcast application can provide a system for entering text messages which can be sent to a location of choice on the Internet. Broadcast applications are well know to persons skilled in the art. Thus, broadcast applications will not be described in great detail herein.

User interface 302 facilitates a user action to create a request to access database 110, transmit data to database 110, and retrieve data from database 110. User interface 302 also facilitates a user action to access an interactive learning software application and updating the interactive learning software application. Also, user interface 302 can facilitate a user action to determine test criteria, define test criteria, define the content of test materials, and define the content of study materials. User interface 302 can further facilitates a user action to assign an identification number to a particular set of test materials. User interface 202 may comprise a display screen, speakers, and an input means, such as a keypad, directional pad, a directional knob, and/or a microphone.

System interface 321 allows the site computer processing device 108 to communicate with the user computer processing device 102 through the internet, LAN, or WAN. System interface 216 also allows the site computer processing device 108 to send and retrieve data from one or more databases 110.

Those skilled in the art will appreciate that the site computer processing device architecture illustrated in FIG. 3 is one possible example of a site computer processing device. However, the invention is not limited in this regard and any other suitable computer processing device architecture can also be used without limitation.

Interactive Learning Graphical User Interfaces

The following figures and accompanying text illustrate various graphical user interfaces (GUIs) and corresponding functions of the present invention. It should be appreciated, however, that the various GUIs disclosed herein are provided for purposes of illustration only and that the present invention is not limited solely to those shown. Different embodiments of the present invention are contemplated where the GUIs can be configured with varying appearances and/or different user interface elements. As such, each GUI can include different varieties and/or combinations of user speech input mechanisms, visual or graphic user input elements, display areas, color schemes, and the like without departing from the spirit of the present invention.

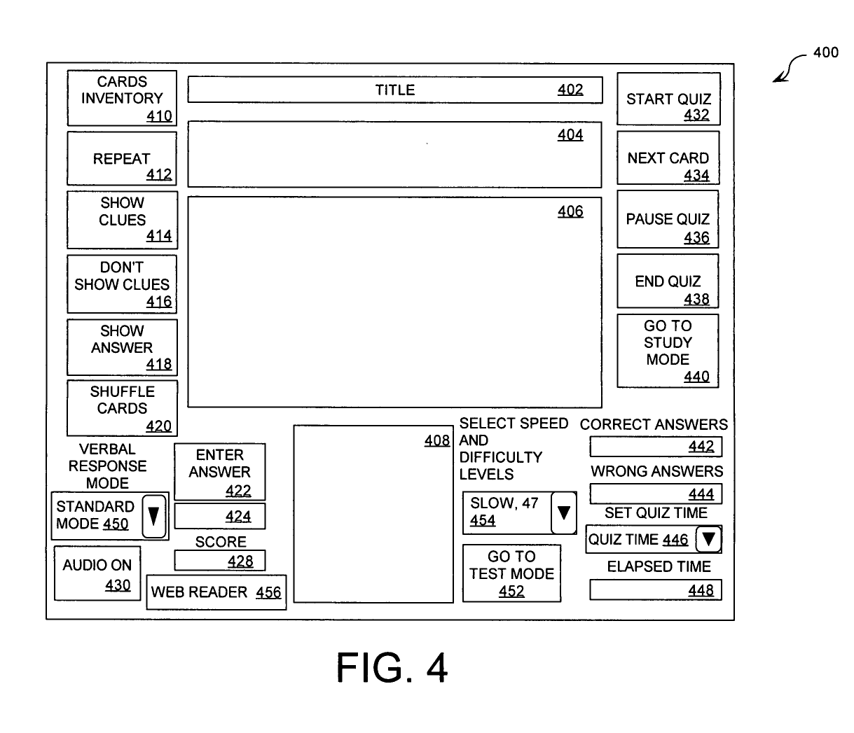

Referring now to FIG. 4, there is provided a schematic illustration of a main GUI 400 that is useful for understanding the invention. Main GUI 400 is an interface through which the various features of an interactive learning system can be accessed. Main GUI 400 is comprised of a title display box 402 and display boxes 404, 406, 408. Main GUI 400 is also comprised of a ‘cards inventory’ button 410, a ‘repeat’ button 412, a ‘show clues’ button 414, a ‘don't show clues’ button 416, a ‘show answer’ button 418, a ‘shuffle cards’ button 420, a ‘start quiz’ button 432, a ‘next card’ button 434, a ‘pause quiz’ button 436, an ‘end quiz’ button 438, a ‘go to study (G/S) mode’ button 440, a ‘go to test mode’ button 452, an ‘audio on’ button 430, and a ‘web reader’ button 456. Main GUI 400 is further comprised of an ‘enter answer’ button 422 and an ‘answer’ text box 424. Main GUI 400 is comprised of a ‘score’ display box 428, a ‘correct answer’ display box 442, a ‘wrong answer’ display box 444, and an ‘elapsed time’ display box 448. Main GUI 400 also includes a ‘set quiz time’ drop down menu 446, a ‘select speed and difficulty levels’ drop down menu 454, and a ‘verbal response mode’ drop down menu 450.

The ‘G/S mode’ button 440 provides a user with a way to trigger an event for entering a study mode. For example, a user clicks the ‘G/S mode’ button 440 to activate study mode. In study mode, an interactive learning program assists a user in studying a subject(s) through one or more practice sessions. In a practice session, a question will be presented (i.e., outputted to a display device in a textual format) to the user in display box 404. It should be understood that the presented question can also be outputted in an auditory format to one or more speakers of user interface 202. A set of answers will be displayed in a textual format to the user in display box 406. It should be understood that the answers can also be outputted in an auditory format to speakers of user interface 202. Subsequently, the user can input an answer utilizing a keyboard for typing an answer in ‘answer text’ box 424. The user can also input an answer utilizing a microphone of user interface 202. If the user types an answer, the user can click ‘enter answer’ button 422. Immediately after inputting a wrong answer, a correct answer will be outputted to a display box 404, 406, 408 and/or to one or more speakers of user interface 202. The current outputted display will remain unchanged for a predefined amount of time to allow the user to analyze the question/answer relationship. Notably, this process does not force a user to continue selecting answers until the correct answer is selected. Also in this study mode, scoring and timing functions are automatically selected to be in an inactive state.

By clicking the ‘G/S mode’ button 442, it's appearance automatically changes to read ‘go to quiz mode.’ A user can return to quiz mode by clicking the ‘go to quiz mode’ button 440. In quiz mode, an assessment mode can selected to be in an active state. In assessment mode, the degree of difficulty associated with question/answer output can be increased or decreased in response to the number of correct answers inputted by a particular user. In effect, a user's competency level can be gauged. After a user completes a quiz, suggestions concerning study levels and learning strategies can be outputted to a display screen and/or to an external device, such as a printer.

The ‘set quiz time’ drop down menu 446 provides a user with a list of quiz time periods. By selecting a desired time period for performing a quiz, the user can compete against clock 218 to try to achieve a desired score before the selected time period expires. According to an embodiment of the invention, clock 218 can be paused while rules, questions, and answers are presented to a user in a textual format and/or a speech format. In this regard, the user will not be penalized for time needed for a lengthy output of data by a computer processing device 102.

The ‘next card’ button 434 provides a user with a way to view a next flash card. When the ‘next card’ button 434 is clicked by a user, a new question is outputted in a textual format to display box 404 and/or in a speech format to one or more speakers of user interface 102. Notably, a score is not adjusted for a correct answer or an incorrect answer in relation to the previous question. According to one embodiment of the invention, the user has the ability to come back to the previous question at a latter time. Also, clock 218 continues to run through this process.

The ‘pause quiz’ button 436 provides a user with a way to pause clock 218. In this regard, the user can take a break during a timed quiz. Once the ‘pause quiz’ button 436 is clicked, it's appearance automatically changes to read ‘resume quiz.’ A user can re-start clock 218 and continue taking the quiz by clicking on the ‘resume quiz’ button 436.

The ‘show clues’ button 414 provides a user with a way to view a display including any available clues stored in database 110 associated with a presented question. A person skilled in the art will appreciate that the clues can be stored in database 110 in any suitable manner. For example, clues can be stored in a table format. The ‘don't show clues’ button 416 provides a user with a way to return to a window displaying an answer(s) to a particular question.

The ‘show answer’ button 418 provides a user with a way to view a correct answer. By clicking the ‘show answer’ button 418, the user will be deducted points for an incorrect answer for that particular question. The ‘shuffle cards’ button 420 provides a user with a way to shuffle a deck of flash cards (i.e., answer a set of questions in a different order than the previously presented order).

The ‘audio on’ button 430 provides a user with a way to launch the text-to-speech engine 206 for converting text into speech. For example, a user can turn on speech output by clicking the ‘audio on’ button 430. Once the ‘audio on’ button 430 is clicked, text (e.g., a question, an answer, a clue, or a response) can be outputted to one or more speakers of user interface 202. According to one embodiment of the invention, the ‘audio on’ button's 430 appearance automatically changes to read ‘audio off’ when a user clicks the button 430. In this regard, the ‘audio off’ button 430 provides a user with a way to turn off speech output.

The ‘cards inventory’ button 410 provides a user with a way to open interactive learning programming functions, such as category selection and/or subcategory selection. The ‘end quiz’ button 438 provides a user with a way to end a quiz or a study session. The ‘repeat’ button 412 provides a user with a way to repeat the last speech output which can include a rule, a question, an answer, a clue, and/or a response.

The ‘verbal response mode’ drop down menu 450 provides a user with a list of verbal response modes for selection. The verbal response modes can include a supportive mode, an encouraging mode, a sarcastic mode, a humorous mode, and/or a stern mode. Each mode includes a set of predefined computer speech outputs associated with specific user actions. For example, the supportive mode can provide a system for a speech output of “good job” in response to an input of a correct answer to a presented question. The ‘select speed and difficulty levels’ drop down menu 454 provides a user with a list of speed levels and difficulty levels for selection.

The ‘go to test mode’ button 452 provides a way for a user to place test mode in an active state. In test mode, data associated with a user's inputted answers are temporality stored in memory 210 of user computer processing device 102 for later transmission to an external device (such as a S/T site 106, a teacher personal computer processing device, or a school network server). According to one embodiment of the invention, the stored data can be transmitted to an external computer processing device in response to completion of a test (e.g., a computer processing device 102 has received answer inputs for each question included in a set of predefined questions). In this mode, a correct/incorrect answer indicator will not be outputted to a display device or a speaker of computer processing device 102. Also, questions are randomly selected from a set of predefined questions so that each user computer processing device 102 will output questions in a different order. Questions will be outputted until a user inputs an answer to each question included in the set of predefined questions. Finally, a user can be given an option to skip and return to a question without selecting an answer if desired. Unanswered questions can be stored in memory 210 and/or in database 110 in a list format (e.g., in a list of unanswered questions or a list of remaining questions from a set of predefined questions).

The ‘web reader’ button 456 provides a way for a user to open a directory of speech enabled web pages. Clicking the ‘web reader’ button 456 opens a user web browser and delivers web page content plus hidden content that is converted to speech by the priority messaging engine 220. Such a feature provides a way to add dynamic content to web pages by including hidden speech tags in a web pages code. It should be understood that such a feature can also offer built in directories of “talking” web pages to support content of a particular interactive learning system application.

Those skilled in the art will appreciate that the GUI illustrated in FIG. 4 is one possible example of a GUI design. However, the invention is not limited in this regard and any other suitable GUI design can also be used without limitation.

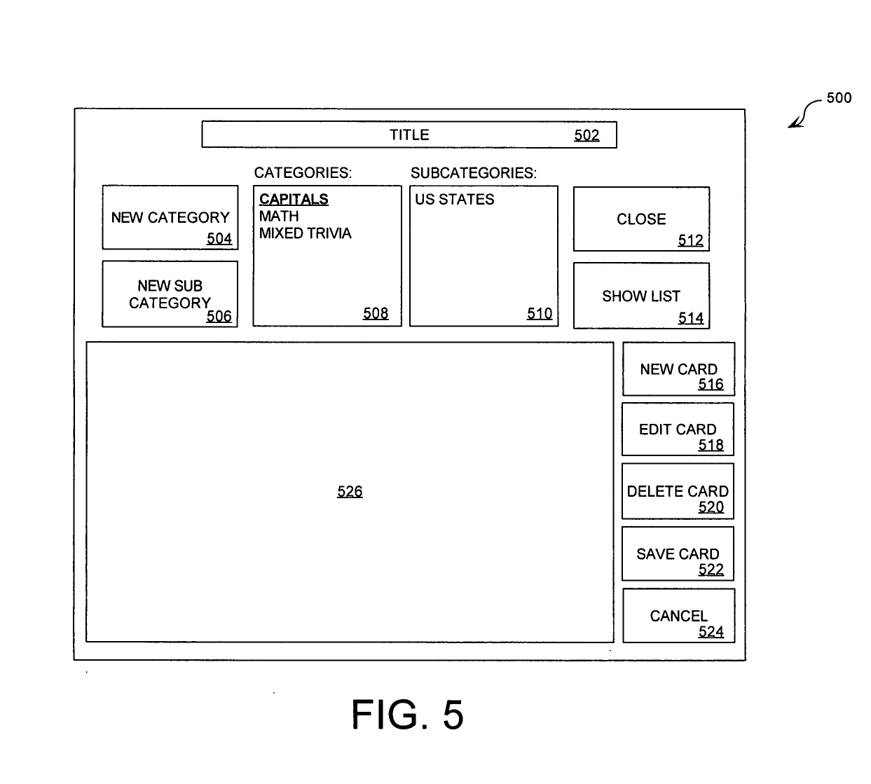

Referring now to FIG. 5, there is provided a schematic illustration of a GUI 500 that is useful for understanding the invention. According to an embodiment of the invention, GUI 500 appears on a display screen of user computer processing device 102 in response to a user action including clicking the ‘cards inventory’ button 410 of GUI 400.

GUI 500 is comprised of a title box 502, a ‘new category’ button 504, a ‘new subcategory’ button 506, a ‘close’ button 512, a ‘show list’ button 514, a ‘new card’ button 516, an ‘edit card’ button 518, a ‘delete card’ button 520, a ‘save card’ button 522, and a ‘cancel’ button 524. GUI 500 is further comprised of a ‘categories’ listbox 508, a ‘subcategories’ listbox 510, and a display box 526.

The ‘categories’ listbox 508 provides a user with a list of available categories of flash cards from which to choose. As shown in FIG. 5, the available categories include capitals, math, and mixed trivia. It should be understood that the categories shown in FIG. 5 are provided as an illustrative embodiment. This invention, may however, be embodied in many different forms and should not be construed as limited to the embodiment set forth in FIG. 5.

A user can highlight and select a category in which the user would like to test. As shown in FIG. 5, the category “capitals” is highlighted and selected. In response to a user action of selecting the “capitals” category, the ‘subcategories’ listbox 510 provides a user with a list of corresponding subcategories. As shown, the “capitals” category includes a subcategory defined as “US states.” It should be understood that the subcategory shown in FIG. 5 is provided as an illustrative embodiment. The invention is not limited in this regard and any other embodiment can be used without limitation. For example, one or more subcategories can be provided for a specific category.

The ‘new category’ button 504 provides a way for a user to define a new category. Similarly, the ‘new subcategory’ button 506 provides a way for a use to define a new subcategory. The ‘close’ button 512 provides a user with a way to close GUI 500.

The ‘show list’ button 514 provides a way for a user to view a list of one or more questions associated with a category and/or a subcategory. The ‘next card’ button 516 provides a user with a way to view a next flash card (i.e., a new question is outputted in a textual format within display box 526 and/or in a speech format through one or more speakers of user interface 202). The ‘edit card’ button 518 provides a user with a way to edit a flash card (i.e., edit a question, an answer, a clue, a category, or a subcategory). The ‘delete card’ button 520 provides a user with a way to delete a flash card. The ‘save card’ button 522 provides a user with a way to save a flash card. The ‘cancel’ button provides a user with a way to reset properties and/or to get previous settings back.

Those skilled in the art will appreciate that the GUI illustrated in FIG. 5 is one possible example of a GUI design. However, the invention is not limited in this regard and any other suitable GUI design can also be used without limitation.

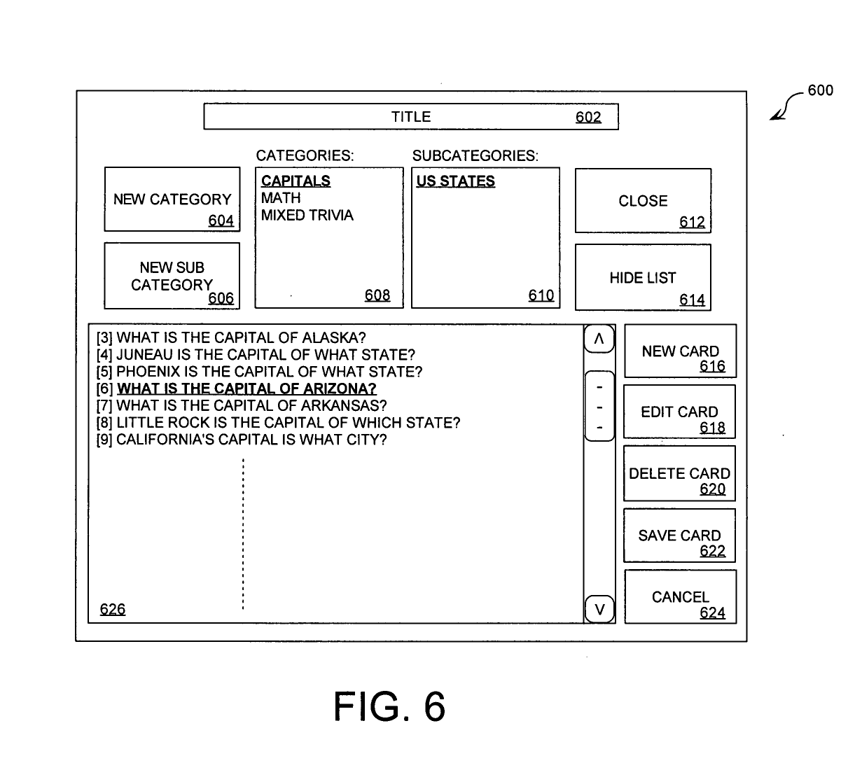

Referring now to FIG. 6, there is provided a schematic illustration of a GUI 600 that is useful in understanding the invention. According to an embodiment of the invention, GUI 600 appears on a display screen of user computer processing device 102 in response to a user action including clicking the ‘show list’ button 514 of GUI 500.

GUI 600 is comprised of a title box 602, a ‘new category’ button 604, a ‘new subcategory’ button 606, a ‘close’ button 612, a ‘show list’ button 614, a ‘new card’ button 616, an ‘edit card’ button 618, a ‘delete card’ button 620, a ‘save card’ button 622, and a ‘cancel’ button 624. GUI 600 is further comprised of a ‘categories’ listbox 608, a ‘subcategories’ listbox 610, and a ‘questions’ scrolling menu 626.

The ‘categories’ listbox 608 provides a user with a list of available categories associated with a set of predefined flash cards. As shown in FIG. 6, the available categories include capitals, math, and mixed trivia. It should be understood that the categories shown in FIG. 6 are provided as an illustrative embodiment. This invention, may however, be embodied in many different forms and should not be construed as limited to the embodiment set forth in FIG. 6.

A user can highlight and select the category in which the user would like to test. As shown in FIG. 6, the category “capitals” is highlighted and selected. In response to a user action of selecting the “capitals” category, the ‘subcategories’ listbox 610 provides a user with a list of the corresponding subcategories. As shown, the “capitals” category includes a subcategory defined as “US states.” It should be understood that the subcategory shown in FIG. 6 is provided as an illustrative embodiment. The invention is not limited in this regard and any other embodiment can be used without limitation. For example, one or more subcategories can be provided for a specific category.

The ‘questions’ scrolling menu 626 provides a user with a list of questions associated with the selected category and/or subcategory. As shown in FIG. 6, the ‘questions’ scrolling menu 626 includes a scroll bar to provide the user with a way to scroll through the list of questions. It should be understood that the ‘questions’ scrolling menu 626 shown in FIG. 6 is provided as an illustrative embodiment. This invention is not limited in this regard and any other widget can be used provided that it allows a user to view one or more questions, select one or more questions, and scroll through one or more questions. For example, a scroll wheel may be implemented in accordance with a particular interactive learning application.

The ‘new category’ button 604 provides a way for a user to define a new category. Similarly, the ‘new subcategory’ button 606 provides a way for a use to define a new subcategory. The ‘close’ button 612 provides a user with a way to close GUI 600.

The ‘hide list’ button 614 provides a user with a way to hide a list of one or more questions displayed in ‘questions’ scrolling menu 626. When a user clicks on the ‘hide list’ button 614, it's appearance will automatically change to read “show list.” A use can view the list again by clicking the ‘show list’ button 614.

The ‘next card’ button 616 provides a user with a way to view a next flash card. The ‘edit card’ button 618 provides a user with a way to edit a flash card. The ‘delete card’ button 620 provides a user with a way to delete a flash card. The ‘save card’ button 622 provides a user with a way to save a flash card. The ‘cancel’ button provides a user with a way to reset properties and/or to get previous settings back.

Those skilled in the art will appreciate that the GUI illustrated in FIG. 6 is one possible example of a GUI design. However, the invention is not limited in this regard and any other suitable GUI design can also be used without limitation.

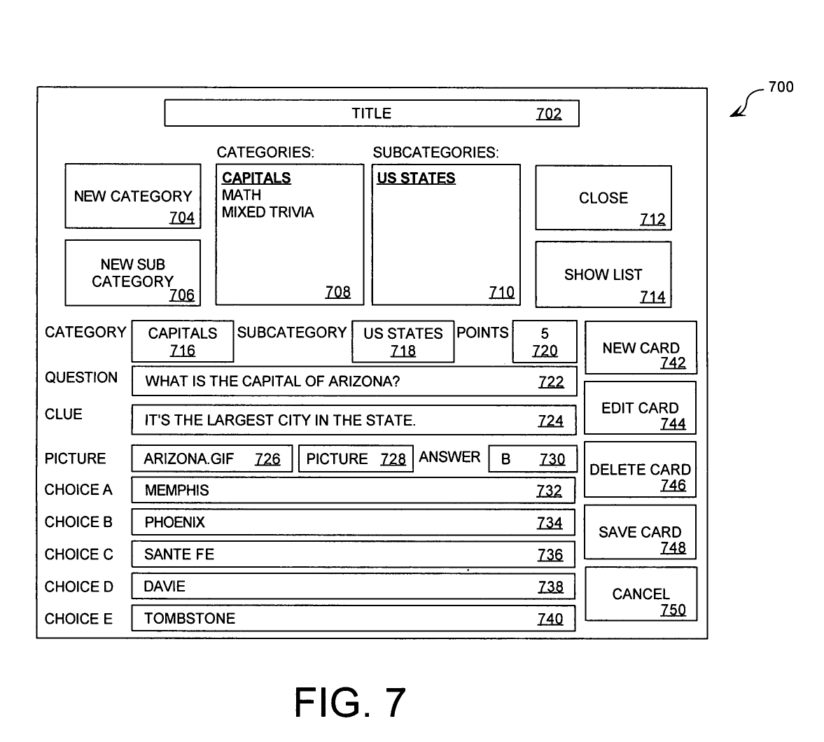

Referring now to FIG. 7, there is provided a schematic illustration of a GUI 700 that is useful for understanding the invention. According to an embodiment of the invention, GUI 700 appears on a display screen of user computer processing device 102 in response to a user action including scrolling to question [6] of ‘questions’ scrolling menu 626, highlighting question [6] of ‘questions’ scrolling menu 626, selecting question [6] of ‘questions’ scrolling menu 626, and clicking the ‘edit card’ button 618 of GUI 600.

As shown in FIG. 7, GUI 700 is comprised of a title box 702, a ‘new category’ button 704, a ‘new subcategory’ button 706, a ‘close’ button 712, a ‘show list’ button 714, a ‘new card’ button 742, an ‘edit card’ button 744, a ‘delete card’ button 746, a ‘save card’ button 748, a ‘cancel’ button 750, and a ‘picture’ button 728. GUI 700 is also comprised of a ‘categories’ listbox 708 and a ‘subcategories’ listbox 710. GUI 700 is further comprised of a ‘category’ text box 716, a ‘subcategory’ text box 718, a ‘points’ text box 720, a ‘question’ text box 722, a ‘clue’ text box 724, a ‘picture’ text box 726, an ‘answer’ text box 730, and ‘answer choice’ text boxes 732, 734, 736, 738, 740.

The ‘category’ text box 716 provides a way for a user to edit, delete, and/or add category data associated with a selected question. Similarly, the ‘subcategory’ text box 718, a ‘points’ text box 720, a ‘question’ text box 722, a ‘clue’ text box 724, a ‘picture’ text box 726, an ‘answer’ text box 730, and ‘answer choice’ text boxes 732, 734, 736, 738, 740 provide ways for a user to edit, delete, and/or add data for each respective topic (e.g., points, question, clue, picture, answer, choice) associated with a selected question.

Those skilled in the art will appreciate that the GUI illustrated in FIG. 7 is one possible example of a GUI design. However, the invention is not limited in this regard and any other suitable GUI design can also be used without limitation.

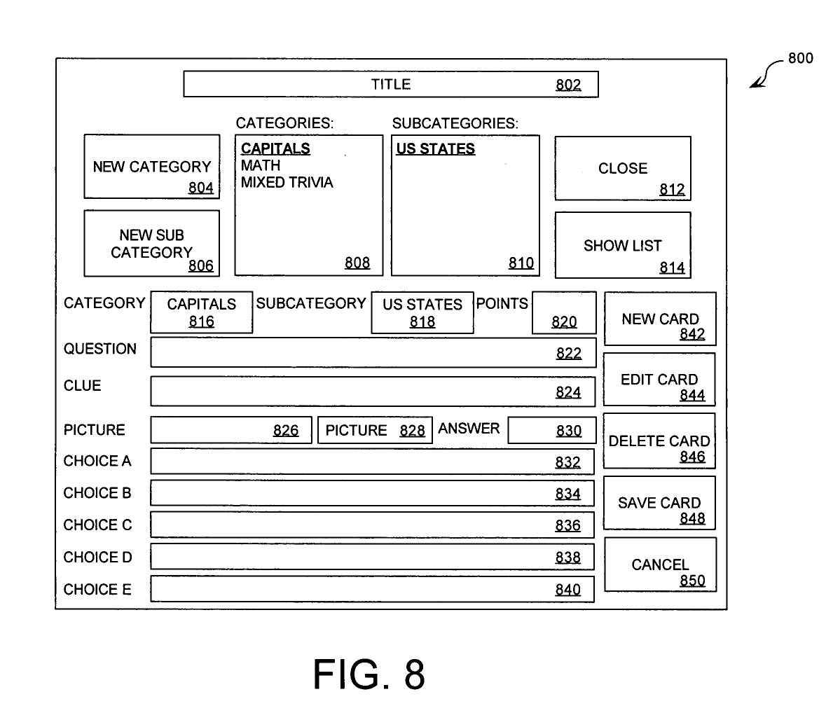

Referring now to FIG. 8, there is provided a schematic illustration of a GUI 800 that is useful for understanding the invention. According to an embodiment of the invention, GUI 800 appears on a display screen of user computer processing device 102 in response to a user action including clicking the ‘new card’ button 516, 616, 742 described above.

As shown in FIG. 8, GUI 800 is comprised of a title box 802, a ‘new category’ button 804, a ‘new subcategory’ button 806, a ‘close’ button 812, a ‘show list’ button 814, a ‘new card’ button 842, an ‘edit card’ button 844, a ‘delete card’ button 846, a ‘save card’ button 848, a ‘cancel’ button 850, and a ‘picture’ button 828. GUI 800 is also comprised of a ‘categories’ listbox 808 and a ‘subcategories’ listbox 810. GUI 800 is further comprised of a ‘category’ text box 816, a ‘subcategory’ text box 818, a ‘points’ text box 820, a ‘question’ text box 822, a ‘clue’ text box 824, a ‘picture’ text box 826, an ‘answer’ text box 830, and ‘answer choice’ text boxes 832, 834, 836, 838, 840.

The ‘category’ text box 816 provides a way for a user to enter text (category data) for association with a question. Similarly, the ‘subcategory’ text box 818, a ‘points’ text box 820, a ‘question’ text box 822, a ‘clue’ text box 824, a ‘picture’ text box 826, an ‘answer’ text box 830, and ‘answer choice’ text boxes 832, 834, 836, 838, 840 provide ways for a user to enter a point value, a question, a clue, a picture file, a correct answer, and answer choices, respectively.

Those skilled in the art will appreciate that the GUI illustrated in FIG. 8 is one possible example of a GUI design. However, the invention is not limited in this regard and any other suitable GUI design can also be used without limitation.

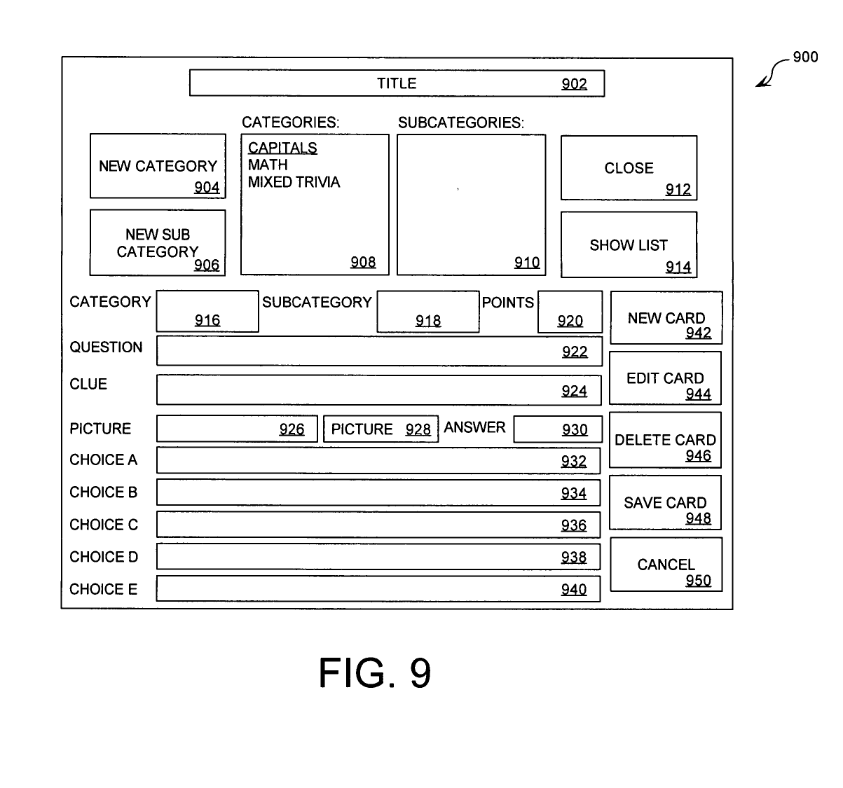

Referring now FIG. 9, there is provided a schematic illustration of a GUI 900 that is useful for understanding the invention. According to an embodiment of the invention, GUI 900 appears on a display screen of user computer processing device 102 in response to a user action including clicking the ‘new category’ button 504, 604, 704, 804 (shown above) or the ‘new subcategory’ button 506, 606, 706, 806 (shown above).

As shown in FIG. 9, GUI 900 is comprised of a title box 902, a ‘new category’ button 904, a ‘new subcategory’ button 906, a ‘close’ button 912, a ‘show list’ button 914, a ‘new card’ button 942, an ‘edit card’ button 944, a ‘delete card’ button 946, a ‘save card’ button 948, a ‘cancel’ button 950, and a ‘picture’ button 928. GUI 900 is also comprised of a ‘categories’ listbox 908 and a ‘subcategories’ listbox 910. GUI 900 is further comprised of a ‘category’ text box 916, a ‘subcategory’ text box 918, a ‘points’ text box 920, a ‘question’ text box 922, a ‘clue’ text box 924, a ‘picture’ text box 926, an ‘answer’ text box 930, and ‘answer choice’ text boxes 932, 934, 936, 938, 940.

The ‘category’ text box 916 provides a way for a user to enter text (category data) for defining a new category. Similarly, the ‘subcategory’ text box 918 provides a way for a user to enter text (subcategory data) for defining a new subcategory.

Those skilled in the art will appreciate that the GUI illustrated in FIG. 9 is one possible example of a GUI design. However, the invention is not limited in this regard and any other suitable GUI design can also be used without limitation.

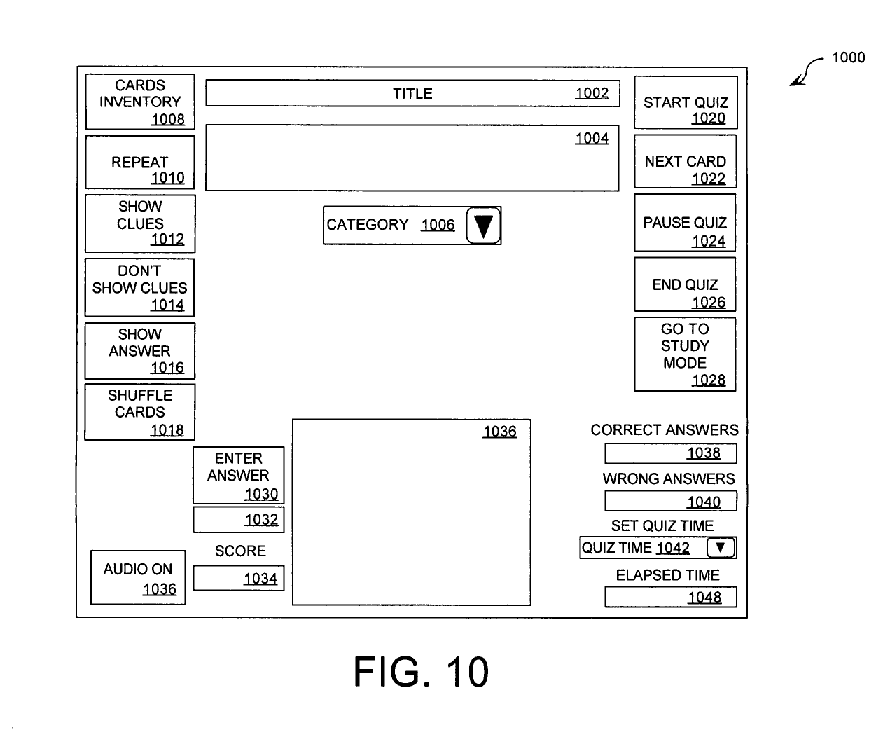

Referring now to FIG. 10, there is provided a schematic illustration of a GUI 1000 that is useful for understanding the invention. According to an embodiment of the invention, GUI 1000 appears on a display screen of user computer processing device 102 prior to beginning a quiz or a study session.

As shown in FIG. 10, GUI 1000 is comprised of a title display box 1002 and display boxes 1004, 1036. GUI 1000 is also comprised of a ‘cards inventory’ button 1008, a ‘repeat’ button 1010, a ‘show clues’ button 1012, a ‘don't show clues’ button 1014, a ‘show answer’ button 1016, a ‘shuffle cards’ button 1018, a ‘start quiz’ button 1020, a ‘next card’ button 1022, a ‘pause quiz’ button 1024, an ‘end quiz’ button 1026, a ‘go to study (G/S) mode’ button 1028, and an ‘audio on’ button 1036. GUI 1000 is further comprised of an ‘enter answer’ button 1030 and an ‘answer’ text box 1032. GUI 1000 is comprised of a ‘score’ display box 1034, a ‘correct answers’ display box 1038, a ‘wrong answers’ display box 1040, and an ‘elapsed time’ display box 1048. GUI 1000 also includes a ‘category’ drop down menu 1006 and a ‘set quiz time’ drop down menu 1042.

The ‘category’ drop down menu 1006 provides a user with a way to select an available flash card category (e.g., capitals, math, trivia) within which to work. According to one embodiment of the invention, a category needs to be selected prior to starting a quiz. For example, a user clicks on the ‘start quiz’ button 1020 prior to selecting a category from the ‘category’ drop down menu 1006. In response to the user action, a message appears in display box 1004. The message states that the user must first choose a category.

Those skilled in the art will appreciate that the GUI illustrated in FIG. 10 is one possible example of a GUI design. However, the invention is not limited in this regard and any other suitable GUI design can also be used without limitation.

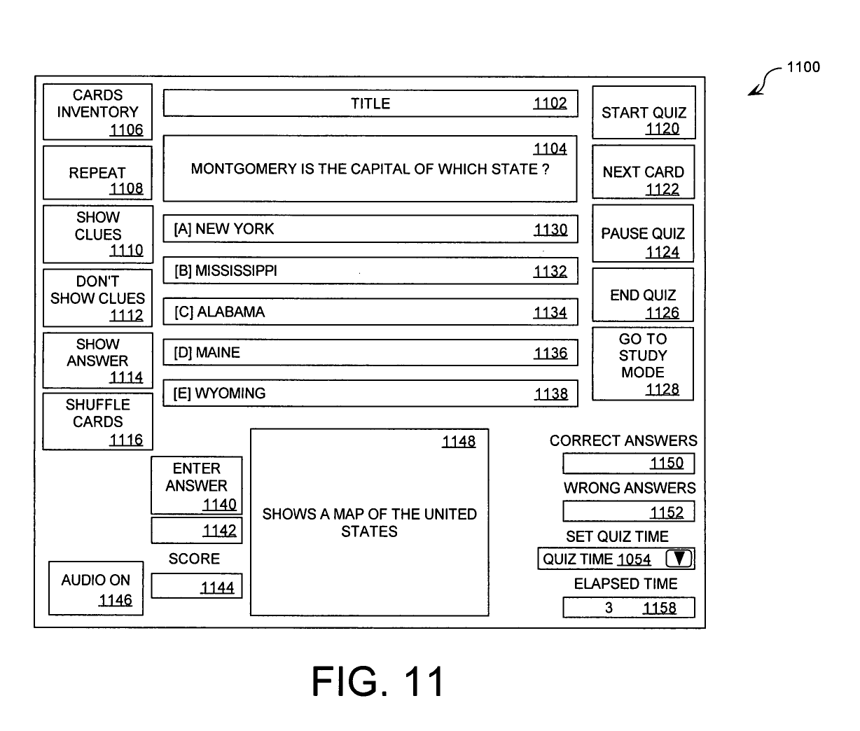

Referring now to FIG. 11, there is provided a schematic illustration of a GUI 1100 that is useful for understanding the invention. According to an embodiment of the invention, GUI 1100 appears on a display screen of user computer processing device 102 in response to a user action including selecting a category from the ‘category’ drop down menu 1006 (described above) and clicking the ‘start quiz’ button 1020 (described above).

As shown in FIG. 11, GUI 1100 is comprised of a title display box 1102 and display boxes 1104, 1148. GUI 1100 is also comprised of a ‘cards inventory’ button 1106, a ‘repeat’ button 1108, a ‘show clues’ button 1110, a ‘don't show clues’ button 1112, a ‘show answer’ button 1114, a ‘shuffle cards’ button 1116, a ‘start quiz’ button 1120, a ‘next card’ button 1122, a ‘pause quiz’ button 1124, an ‘end quiz’ button 1126, a ‘go to study (G/S) mode’ button 1128, and an ‘audio on’ button 1146. GUI 1100 is further comprised of an ‘enter answer’ button 1140 and an answer text box 1142. GUI 1100 is comprised of a ‘score’ display box 1144, a ‘correct answers’ display box 1150, a ‘wrong answers’ display box 1152, and an ‘elapsed time’ display box 1158. GUI 1100 also includes a ‘set quiz time’ drop down menu 1154. There is also provided ‘answer choice’ display boxes 1130, 1132, 1134, 1136, 1138.

Textual information (e.g., a question) is outputted to display box 1104. Similarly, textual information (e.g., answers) is outputted to answer choice display boxes 1130, 1132, 1134, 1136, 1138. It should be appreciated that the text (e.g., a question and an answer) outputted to the display boxes 1104, 1130, 1132, 1134, 1136, 1136 can also be outputted to one or more speakers. For example, a user clicks on the ‘audio on’ button 1146. In response to this user action, the text-to-speech engine 206 is launched (i.e., the user turned on computer speech). In such a scenario, questions, answers, clues, and responses are presented to a user in a speech form. It should be understood that information can be presented to a user entirely in a textual form, entirely in a speech form, partly in a textual form, partly in a speech form, or in any other form known in the art. It should be further appreciated that information can be presented visually in a predefined language or in a language selected by a user. Likewise, information can be presented to a user in a speech format in a predefined language or in a language selected by a user. According to one embodiment of the invention, a default language is English.

The ‘answer’ text box 1142 allows a user to type in an answer (for example, A, B, C, D, or E). After typing in an answer, the user can click on the ‘enter answer’ button 1140 for entering the answer. Time information is outputted to the ‘elapsed time’ display box 1158. According to an embodiment of the invention, the time information includes a time value representing the length of time that has lapsed since presentation of a first question to a user.

As shown in FIG. 11, a visual illustration (e.g., a map of the United States) is displayed in display box 1148. The visual illustration is presented to a user for assisting the user in correctly answering a question. It should be appreciated that auditory information can accompany a visual illustration. The auditory information can be presented to a user.

Those skilled in the art will appreciate that the GUI illustrated in FIG. 11 is one possible example of a GUI design. However, the invention is not limited in this regard and any other suitable GUI design can also be used without limitation.

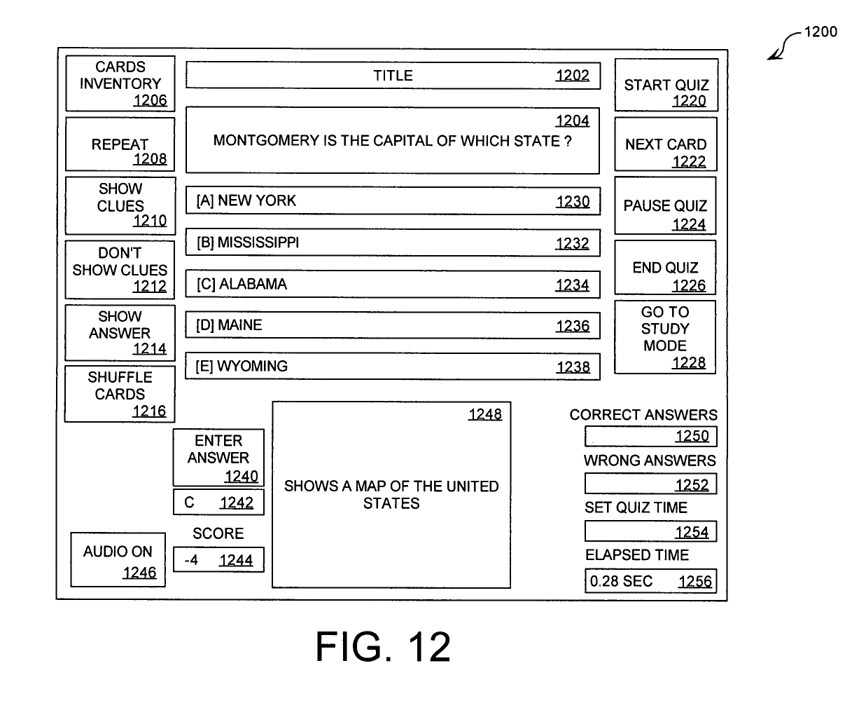

Referring now to FIG. 12, there is provided a schematic illustration of a GUI 1200 that is useful for understanding the invention. According to an embodiment of the invention, GUI 1200 appears on a display screen of user computer processing device 102 in response to user actions including typing an answer in the ‘answer’ text box 1142 (described above) and clicking the ‘enter answer’ button 1140 (described above).

As shown in FIG. 12, GUI 1200 is comprised of a title display box 1202 and display boxes 1204, 1248. GUI 1200 is also comprised of a ‘cards inventory’ button 1206, a ‘repeat’ button 1208, a ‘show clues’ button 1210, a ‘don't show clues’ button 1212, a ‘show answer’ button 1214, a ‘shuffle cards’ button 1216, a ‘start quiz’ button 1220, a ‘next card’ button 1222, a ‘pause quiz’ button 1224, an ‘end quiz’ button 1226, a ‘go to study (G/S) mode’ button 1228, and an ‘audio on’ button 1246. GUI 1200 is further comprised of an ‘enter answer’ button 1240 and an ‘answer’ text box 1242. GUI 1200 is comprised of a ‘score’ display box 1244, a ‘correct answers’ display box 1250, a ‘wrong answers’ display box 1252, and an ‘elapsed time’ display box 1256. GUI 1200 also includes a ‘set quiz time’ drop down menu 1254. There is also provided ‘answer choice’ display boxes 1230, 1232, 1234, 1236, 1238.

As shown in FIG. 12, a score can be displayed in the ‘score’ display box 1244. The score can take account for correctly answered questions and incorrectly answered questions. Also, the amount of time lapsed since presentation of a question is displayed in the ‘elapsed time’ display box 1256.

It should be appreciated that a visual indicator of whether the user answered the question correctly or incorrectly can be displayed in display box 1204, 1248. A speech indicator as to whether the user answered a question correctly can be outputted to one or more speakers of user interface 202. Also, a visual illustration (e.g., a map of the United States with a highlighted state) can be displayed in display box 1248 for assisting the user in answering a presented question correctly. It should be further appreciated that auditory information can be outputted concurrently with the visual illustration to further assist a user in answering a presented question correctly.

Those skilled in the art will appreciate that the GUI illustrated in FIG. 12 is one possible example of a GUI design. However, the invention is not limited in this regard and any other suitable GUI design can also be used without limitation.

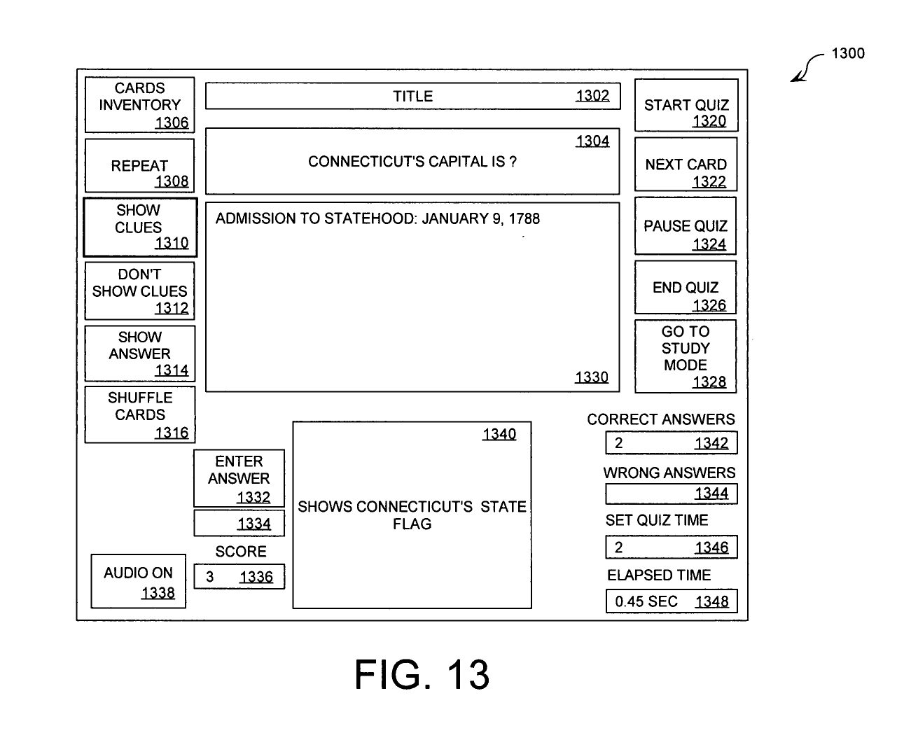

Referring now to FIG. 13, there is provided a schematic illustration of a GUI 1300 that is useful for understanding the invention. According to an embodiment of the invention, GUI 1300 appears on a display screen of user computer processing device 102 in response to user actions including clicking on the ‘show clues’ button 1310 (described above).

As shown in FIG. 13, GUI 1300 is comprised of a title display box 1302 and display boxes 1304, 1330, 1340. GUI 1300 is also comprised of a ‘cards inventory’ button 1306, a ‘repeat’ button 1308, a ‘show clues’ button 1310, a ‘don't show clues’ button 1312, a ‘show answer’ button 1314, a ‘shuffle cards’ button 1316, a ‘start quiz’ button 1320, a ‘next card’ button 1322, a ‘pause quiz’ button 1324, an ‘end quiz’ button 1326, a ‘go to study (G/S) mode’ button 1328, and an ‘audio on’ button 1338. GUI 1300 is further comprised of an ‘enter answer’ button 1332 and an answer text box 1334. GUI 1300 is comprised of a ‘score’ display box 1336, a ‘correct answer’ display box 1342, a ‘wrong answer’ display box 1344, and an ‘elapsed time’ display box 1348. GUI 1300 also includes a ‘set quiz time’ drop down menu 1346.

The ‘show clues’ button 1310 provides a user with a way to view clues for assisting the user in answering a question. According to an embodiment of the invention, a textual clue can be displayed in display box 1330 in response to a user action of clicking the ‘show clues’ button 1310. A visual illustration can be displayed in display box 1340 for assisting a user in answering a presented question correctly. It should be further appreciated that auditory information can accompany the visual illustration to further assist a user in answering a presented question correctly.

Those skilled in the art will appreciate that the GUI illustrated in FIG. 13 is one possible example of a GUI design. However, the invention is not limited in this regard and any other suitable GUI design can also be used without limitation.

User Process for Interactive Learning

Referring now to FIG. 14, there is provided a flow diagram of a user process 1400 that is useful for understanding the invention. Process 1400 begins with step 1402 and continues with step 1404. In step 1404, a user inputs data for building an assessment matrix. This step can involve selecting a speed level and/or a difficulty level. This step can involve selecting a speed level and a difficulty level from a ‘select speed and difficulty level’ drop down menu 454. Subsequently, the user selects a test mode, a quiz mode, or a study mode in step 1406. Upon selecting a mode, the user starts a quiz, a test, or a study session. In step 1410, the user inputs an answer for one or more questions. This step can involve typing answers in an ‘answer’ text box 424 and clicking an ‘enter answer’ button 422. This step can further include speaking into a microphone of user interface 202. After answering the one or more questions, the user reviews a generated report in step 1412. The generated report can include suggestions concerning study levels, suggestions concerning learning strategies, a list of the user's answers associated with each question, a list of correct answers associated with each question, a number of incorrect answers, a number of correct answers, and/or a score. After reviewing the report, step 1414 is performed where process 1400 returns to step 1402.

A person skilled in the art will appreciate that the user process 1400 is one embodiment of a user process. The invention is not limited in this regard and any other user process can be used without limitation.

Interactive Learning Software Routine

The following figure and accompanying text illustrate an interactive learning software routine in accordance with the present invention. It should be appreciated, however, that the interactive learning software routine disclosed herein is provided for purposes of illustration only and that the present invention is not limited solely to the interactive learning software routine shown. It should be understood that computer program code for carrying out the routines and functions of the present invention can be written in an object orientated programming language such as Java®, Smalltalk, C++, or Visual Basic. However, the computer program code for carrying out the routines and functions of the present invention can also be written in conventional procedural programming languages, such as “C” programming language.

Referring now to FIG. 15, there is provided a flow diagram of an interactive learning software routine 1500 that is useful for understanding the invention. Software routine 1500 begins with step 1502 and continues with step 1504. In step 1504, an assessment matrix is built. The assessment matrix can include data relating to a skill level and a difficulty level. The assessment matrix can include default data of a user's educational level (e.g., first grade, second grade) when a user is a first-time-user of the interactive learning system 100. After building an assessment matrix, step 1506 is performed where an interactivity model for a user is generated. The interactivity model can include one or more questions associated with one or more skill levels and/or one or more difficulty levels. The interactivity model can also include one or more questions associated with a category and/or a subcategory. The interactivity model can control the type of feedback (prompts and queues) provided to a user. Subsequently, a test mode, a quiz mode, or a study mode is placed in an active state in response to a user action. As discussed above, the user action can include clicking on a ‘go to test mode’ button 452 or a ‘go to study mode’ button 440. In step 1510, a question and associated answer choices are outputted. This step can involve outputting the question and answer data to a display device of computer processing device 102 and/or to one or more speakers of computer processing device 102. This can be accomplished through use of the text-to-speech engine 206. It should be understood that question and answer data can be concurrently outputted in a text format and a speech format. In step 1512, one or more clues to the presented question can be outputted. This step can involve automatically outputting clue data. Alternatively, this step can involve outputting clue data in response to a user action including clicking a ‘show clues’ button 414. The clue data can be outputted to a display screen of computer processing device 102 and/or to one or more speakers of computer processing device 102. After step 1512, step 1514 is performed where an answer input is received from a user utilizing an input device such as a keyboard and/or a microphone. The data associated with the received answer inputs is then processed. This step can involve storing the answer input in database 110 in a table format (i.e., user performance table). It should be appreciated that the user performance table can be stored such that it can be used for assessing a user's performance after completion of one or more tests, quizzes, and/or study sessions. In step 1516, a response can be generated and outputted to a display device and/or one or more speakers. This step can involve assessing the difficulty of the question, the received answer from the user, the number of incorrect answer inputs, and the time it took between outputting a question and receiving an answer input. This analysis can assist in determining an appropriate response, such as “Hey what is going on . . . you should be able to get these questions . . . are you playing with me,” “Hey buddy, try using the questions tips,” or “If you look carefully at the picture you will find the correct answer.”

Subsequently, software routine 1500 continues with a decision step. If all questions have not been outputted (1518:NO), software routine 1500 returns to step 1510. If all question have been outputted (1518:YES), software routine 1500 continues to another decision step. If an answer input have not been received for all outputted questions (1520:NO), software routine 1500 returns to step 1510. If an answer input has been received for all outputted questions (1520:YES), software routine 1500 continues to another decision step 1522. In decision step 1522, it is determined whether or not the assessment matrix needs to be modified. This step can involve assessing the difficulty of the question, the received answer from the user, the number of incorrect answer inputs, and the time it took between outputting a question and receiving an answer input. Such a step assures that appropriate questions will be outputted for assuring optimized teaching geared towards the abilities of a particular user. If the assessment matrix needs to be modified (1522: YES), the assessment matrix is modified in accordance with a particular interactive learning application and a users performance abilities. After modifying the assessment matrix, software routine 1500 continues with step 1526. In step 1526, a report is generated. The report is outputted to a display screen or to an external device such as a printer. After step 1526, step 1528 is performed where software routine 1500 returns to 1502. If the assessment matrix does not need to be modified (1522: NO), control passes to step 1526. Subsequently, control passes to step 1528 where software routine 1500 returns to 1502.

A person skilled in the art will appreciate that the present invention can designed with different modules for different types of users. For example, a teacher module and/or an administrator module can be provided with editing tools, data collection functions, and analysis tools. Also, a teacher module or administrator module can provide for configurable system for purposes of evaluating a user's skill set and/or level of education. For example, a teacher module or administrator module can also be provided with a set of customizable goals associated with a particular skill level and/or difficulty level.

It should be appreciated that an administrator module can be provided with a broadcast application. The broadcast application provides a system to enter text messages which can be sent to a location of choice on the Internet. Each computer processing device running an interactive software routine in accordance with the present invention will automatically, at predetermined intervals, retrieve the messages. The messages will then be outputted to a display device of computer processing device and/or one or more speakers of computer processing device. Such a system can be used to alert a user to new content available or to give a user instruction on educational assignments.

A person skilled in the art will also appreciate that the present invention can designed with a mode for challenging a user with content pulled from one or more skill levels, one or more difficulty levels, and/or one or more educational levels. Also, the present invention can designed such that questions can be pulled from skill levels and/or difficulty levels based on the percentage of correctly inputted answers. For example, questions can be selected from a greater level of difficulty when an answer input or a percentage (e.g., 75%) of answer inputs are correct answer inputs for a particular question or a set of particular questions (e.g., 30 to 40 questions), respectively. Similarly, questions can be selected from a lesser level of difficulty when an answer input or a percentage (e.g., 50%) of answer inputs are incorrect answer inputs for a question or a set of particular questions (e.g., 30 to 40 questions), respectively.

A person skilled in the art will further appreciate that the present invention can be designed such that a question can be outputted in a different language when a defined number of incorrect input answers are received for a particular question. Also, the present invention can be designed with a default setting and a matrix setting. In the default setting, questions and responses will be randomly selected for output. In the matrix setting, questions and responses will be selected for output based on a set of criteria relating to user responses.

Priority Messaging Engine Software Routine

FIG. 16A through FIG. 16D represent a flow diagram of a priority messaging engine 220 software routine 1600 that is useful for understanding the invention. As shown in FIG. 16A through FIG. 16D, software routine 1600 includes a message broadcast application. The message broadcast application allows for the creation and placement of text messages in a unique location on the Internet 104 where they may be automatically received by a specific group of computer processing devices 102 defined by their use of a computer software application that instructs the local computer to access the unique location where text messages are placed and to retrieve newly posted material.

Software routine 1600 also includes a client application. The client application can be installed on a user computer processing device 102 and can connect to one or more text-to-speech engines 206 on the host computer processing device 102. The client application is designed to check a specific location or locations via the Internet 104 for newly posted data. The client application is designed to automatically check for new information at regular intervals and will only notify a user when new information is found. When new data is retrieved, a message box will be outputted to a display device. The message can include a question asking a user if they would like to hear a new message. At the same time, the computer processing device 102 will begin outputting a message to one or more speakers (if a suitable text-to-speech engine 206 is found). The message can include an alert to a user that a new message is available. When a user accepts a message by responding to a prompt, text is outputted to a display device and/or to one or more speakers.

As shown in FIG. 16A through FIG. 16D, software routine 1600 includes a web reader function. A web reader function is designed to automatically check the Internet 104 to find a list of Internet locations and then present a directory of links to specific web pages. When accessed by an interactive software application from this directory, a directory can include unique content that will cause user computer processing device 102 to use an available text-to-speech engine 206 and output the content to one or more speakers. A user accessing a web page without an interactive software application including a priority messaging application will not have access to the unique verbal content.

The message broadcast application, the client application, and the web reader function work together to provide for the distribution of text and spoken content to a closed group of users in a very efficient manner with text being retrieved from a specific Internet location and converted to speech by the user's computer processing device 102.

A person skilled in the art will appreciate that the priority messaging software routine 1600 is one embodiment of a priority messaging software routine. The invention is not limited in this regard and any other priority messaging software routine can be used without limitation.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for learning that combines physical, verbal and visual interaction between a computer processing device and a user, comprising:
building an assessment matrix;
generating an interactivity model for said user;
outputting at least one question and a plurality of answer choices to a display device of said computer processing device or to at least one speaker of said computer processing device;
receiving an answer input for said at least one question from said user;
processing said answer input to build a user performance table;
generating a response based on said answer input and outputting said response to said display device or said at least one speaker; and
modifying said assessment matrix to accommodate a level of expertise demonstrated by said user.

2. The method according to claim 1, wherein said building an assessment matrix step comprises receiving a speed level and a difficulty level input from said user; and storing said speed level and said difficulty level input in a database.

3. The method according to claim 1, wherein said outputting at least one question step comprises outputting said at least one question and said plurality of answer choices to a display device of said computer processing device and to at least one speaker of said computer processing device.

4. The method according to claim 1, wherein said generating a response step comprises generating said response in accordance with a verbal response mode.

5. The method according to claim 1, wherein said outputting said response comprises outputting said response to said display device and to said at least one speaker.

6. The method according to claim 1, further comprising outputting at least one clue to said display device and to said at least one speaker to assist said user in correctly answering said at least one question.

7. The method according to claim 1, further comprising placing a test mode, a study mode, or a quiz mode in an active state.

8. The method according to claim 7, further comprising timing a test, a quiz, or a study session.

9. The method according to claim 1, further comprising providing a system to allow a user to edit, add, and delete a question and associated answer choices in response to a user action; and storing an edited or an added question and associated answer choices in a memory device.

10. The method according to claim 1, further comprising providing a system to allow a user to add a category, to delete a category, to add a subcategory, and delete a subcategory; and storing an added category and an added subcategory in a memory device.

11. The method according to claim 1, further comprising generating at least one report and outputting said report to said display device or an external device.

12. A computer program product for learning that combines physical, verbal and visual interaction to assess and help raise the skill levels of a user, the computer program product comprising:
computer readable storage medium having computer readable code embodied in said medium, the computer readable program code comprising:
computer readable program code configured to build an assessment matrix;
computer readable program code configured to generate an interactivity model for said user;
computer readable program code configured to output at least one question and a plurality of answer choices to a display device or at least one speaker;
computer readable program code configured to receive an answer input for said at least one question from an input device;
computer readable program code configured to process said answer input to build a user performance table;
computer readable program code configured to generate a response based on said answer input and outputting said response to a display device or at least one speaker;
computer readable program code configured to modify said assessment matrix to accommodate a level of expertise demonstrated by said user; and
computer readable program code configured to generate a report.

13. The computer program product in accordance with claim 12, further comprising computer readable program code configured to receive speed level and difficulty level inputs from said user; and store said speed level and difficulty level inputs in a database.

14. The computer program product in accordance with claim 12, further comprising computer readable program code configured to output said at least one question and said plurality of answer choices to said display device and to said at least one speaker.

15. The computer program product in accordance with claim 12, further comprising computer readable program code configured to generate a response in accordance with a verbal response mode; and computer readable program code configured to output said response to said display device and or to said at least one speaker.

16. The computer program product in accordance with claim 12, further comprising computer readable program code configured to output at least one clue to said display device and or to said at least one speaker to assist said user in correctly answering said at least one question.

17. The computer program product in accordance with claim 12, further comprising computer readable program code configured to place a test mode, a study mode, or a quiz mode in an active state.

18. The computer program product in accordance with claim 12, further comprising computer readable program code configured to time a test, a quiz, or a study session.

19. The computer program product in accordance with claim 12, further comprising computer readable program code configured to set a speed level and a difficulty level for questions to be presented to a user.

20. The computer program product in accordance with claim 12, further comprising computer readable program code configured to allow said user to edit, add, and delete a question and associated answer choices; computer readable program code configured to store a question and associated answer choices in a memory device in response to a user action; computer readable program code configured to allow said user to add and delete a category; computer readable program code configured to allow said user to add and delete a subcategory; and computer readable program code configured to store a category and a subcategory in response to a user action.
